(19) United States
(12) Patent Application Publication
(10) Pub. No.: US 2024/0429743 A1
(43) Pub. Date: Dec. 26, 2024

(54) STRUCTURE FOR IMPROVING PERFORMANCE OF RESONATOR

(71) Applicant: Samsung Electronics Co., Ltd., Suwon-si (KR)

(72) Inventors: Jaehyun PARK, Suwon-si (KR); Beomwoo GU, Suwon-si (KR); Joonhong KIM, Suwon-si (KR); Jaeseok PARK, Suwon-si (KR); Sungku YEO, Suwon-si (KR); Youngho RYU, Suwon-si (KR)

(21) Appl. No.: 18/813,660

(22) Filed: Aug. 23, 2024

Related U.S. Application Data
(63) Continuation of application No. PCT/KR2023/000091, filed on Jan. 3, 2023.

(30) Foreign Application Priority Data
Feb. 28, 2022 (KR) 10-2022-0026311

(51) Int. Cl. H02J 50/00; H02J 7/00; H02J 50/12

(52) U.S. Cl. CPC H02J 50/005; H02J 7/0044; H02J 50/12

(57) ABSTRACT

According to various embodiments, a cover device capable of being coupled to a wireless power-receiving unit comprising circuitry configured to receive wireless power from a wireless power-transmitting unit comprising circuitry may comprise: a first capacitor; a first coil connected to the first capacitor; a ferrite sheet arranged, on at least a portion of the first coil, in the coupling direction between the wireless power-receiving unit and the cover device; and a metal sheet arranged, on at least a portion of the ferrite sheet, in the coupling direction between the wireless power-receiving unit and the cover device. The first capacitor and the first coil can form a closed loop. A first resonance frequency of the first coil can be higher than a second resonance frequency of a second coil of the wireless power-receiving unit.

### CROSS-REFERENCE TO RELATED APPLICATIONS

This application is a continuation of International Application No. PCT/KR2023/000091 designating the United States, filed on Jan. 3, 2023, in the Korean Intellectual Property Receiving Office and claiming priority to Korean Patent Application No. 10-2022-0026311, filed on Feb. 28, 2022, in the Korean Intellectual Property Office, the disclosures of each of which are incorporated by reference herein in their entireties.

### BACKGROUND

### Field

The disclosure relates to a structure for improving the performance of a resonator.

### Description of Related Art

Wireless charging technology uses wireless power transmission and reception and refers to a technology capable of automatically charging the battery of a mobile phone without connecting the mobile phone to a separate charging connector, for example, when the mobile phone comes into contact with a wireless power transmitting device or comes within a certain distance of the wireless power transmitting device. This wireless charging technology has the advantage of making electronic devices more waterproof by eliminating the need for a connector to supply power to the electronic devices, and making the electronic devices more portable by eliminating the need for a wired charger.

Wireless charging technology includes an electromagnetic induction scheme using coils, a resonance scheme using resonance, and an RF/microwave radiation scheme, which converts electrical energy into electromagnetic waves and transmits the electromagnetic waves.

In recent years, wireless charging technology using an electromagnetic induction scheme or a resonance scheme has been popularized for electronic devices such as smartphones, for example. When a power transmitting unit (PTU) (e.g., a wireless power transmitting device) and a power receiving unit (PRU) (e.g., a smartphone or wearable electronic device) come into contact with each other or approach within a certain distance from each other, the battery of the power receiving unit may be charged by methods such as electromagnetic induction or electromagnetic resonance between the transmission coil of the power transmitting unit and the reception coil of the power receiving unit.

In the case of wireless charging technology that do not require connection of a separate charging connector, there is a need for a method to improve wireless charging efficiency.

### SUMMARY

Embodiments of the disclosure provide a structure for improving the performance of resonators that are disposed in an electronic device (e.g., a power receiving unit) and a cover of the electronic device.

In accordance with various example embodiments, a cover device couplable to a power receiving unit comprising circuitry configured to receive wireless power from a power transmitting unit comprising circuitry may include: a first capacitor, a first coil connected to the first capacitor, a ferrite sheet disposed on at least a portion of the first coil in a direction of coupling between the power receiving unit and the cover device, and a metal sheet disposed on a least a portion of the ferrite sheet in the direction of coupling between the power receiving unit and the cover device. The first capacitor and the first coil may be configured to form a closed loop. A first resonant frequency of the first coil may be higher than a second resonant frequency of a second coil of the power receiving unit.

In accordance with various example embodiments, a power receiving unit comprising circuitry configured to receive wireless power from a power transmitting unit comprising circuitry may include: a housing, a display disposed on one side of the housing, a cover disposed on an other side of the housing opposite the display, the cover including: a first capacitor, a first coil connected to the first capacitor, a ferrite sheet disposed in a direction of the one side on at least a portion of the first coil, and a metal sheet disposed in the direction of the one side on at least a portion of the ferrite sheet, and a second coil disposed between the display and the cover. The first capacitor and the first coil may be configured to form a closed loop. A first resonant frequency of the first coil may be higher than a second resonant frequency of the second coil.

It is possible to improve the charging efficiency of wireless power from the power transmitting unit by providing the structure for improving the performance of a resonator according to various example embodiments.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an example configuration of a power transmitting unit and a power receiving unit according to various embodiments;

FIG. 2 is an exploded perspective view illustrating an electronic device and a cover device according to various embodiments;

FIG. 3 is a cross-sectional view illustrating an example structure of resonators which are disposed in an electronic device and a cover device according to various embodiments;

FIG. 4 is a diagram illustrating an example structure of resonators which are disposed in an electronic device and a cover device according to various embodiments;

FIG. 5 is an exploded perspective view illustrating an example structure of resonators which are disposed in an electronic device and a cover device according to various embodiments;

FIG. 6 is an exploded perspective view illustrating an example structure of resonators which are disposed in an electronic device and a cover device according to various embodiments;

FIG. 7 is a cross-sectional view illustrating an example structure of resonators which are disposed in an electronic device and a cover device according to various embodiments;

FIG. 8 is a diagram illustrating an example structure of a metal sheet disposed in a cover device according to various embodiments;

FIG. 9 is a diagram illustrating example circuit structures of an electronic device and a cover device according to various embodiments;

FIG. 10 is a graph illustrating the resonance of an electronic device and a cover device according to various embodiments;

FIG. 11 is a diagram illustrating an example structure of a resonator of an electronic device including a cover according to various embodiments; and

FIG. 12 is a cross-sectional view illustrating an example structure of a resonator of an electronic device including a cover according to various embodiments.

### DETAILED DESCRIPTION

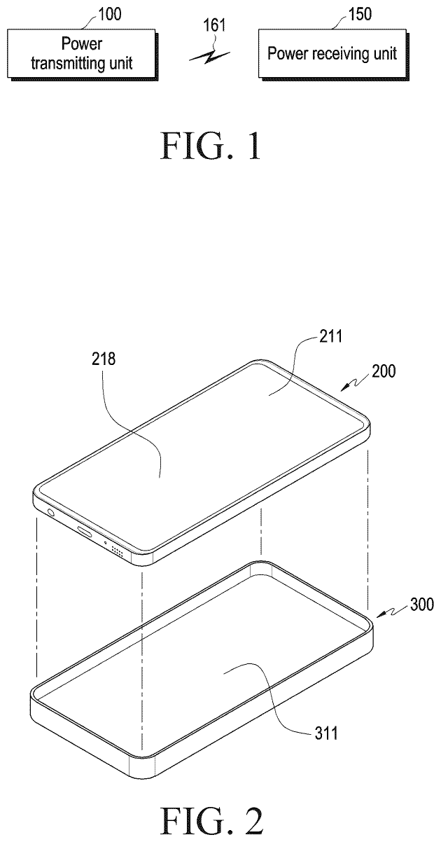

FIG. 1 is a block diagram illustrating an example configuration of a power transmitting unit and a power receiving unit according to various embodiments.

Referring to FIG. 1, a power transmitting unit (e.g., including circuitry) 100 according to various embodiments may wirelessly transmit power 161 to power receiving unit (e.g., including circuitry) 150. The power transmitting unit 100 may transmit the power 161 to the power receiving unit 150 according to various charging methods. For example, the power transmitting unit 100 may transmit the power 161 using an induction scheme. When the power transmitting unit 100 uses the induction scheme, the power transmitting unit 100 may include, for example, a power source, a DC-to-AC conversion circuit, an amplification circuit, an impedance matching circuit, at least one capacitor, at least one coil, a communication modulation/demodulation circuit, and the like. The at least one capacitor may comprise a resonant circuit together with the at least one coil. The power transmitting unit 100 may be implemented in a manner defined by the wireless power consortium (WPC) standard (or the Qi standard). For example, the power transmitting unit 100 may transmit the power 161 using a resonance scheme. In the case of using the resonance scheme, the power transmitting unit 100 may include, for example, a power source, a DC-to-AC conversion circuit, an amplification circuit, an impedance matching circuit, at least one capacitor, at least one coil, and an out-of-band short-range communication module (e.g., a Bluetooth low energy (BLE) short-range communication module). The at least one capacitor and the at least one coil may comprise a resonant circuit. The power transmitting unit 100 may be implemented in a manner defined by the Alliance for Wireless Power (A4WP) standard (or, the air fuel alliance (AFA) standard). The power transmitting unit 100 may include a coil capable of generating a time-varying magnetic field, which has a magnitude changing over time, when an alternating current flows according to the resonance scheme or the induction scheme. The process of generating the magnetic field by the power transmitting unit 100 may be described as the power transmitting unit 100 outputting or wirelessly transmitting the power 161. Furthermore, the power receiving unit 150 may include a coil in which an induced electromotive force is generated by a magnetic field formed around the coil and having a magnitude changing over time. The process of generating the induced electromotive force through the coil by the power receiving unit 150 may be described as the power 161 being input to the power receiving unit 150 or the power receiving unit 150 receiving power 161 wirelessly.

The power transmitting unit 100 of various embodiments of the disclosure may communicate with the power receiving unit 150. For example, the power transmitting unit 100 may communicate with the power receiving unit 150 in an in-band scheme. The power transmitting unit 100 or the power receiving unit 150 may change the load (or, the load impedance) of data to be transmitted, for example, using an on/off keying modulation scheme. The power transmitting unit 100 or the power receiving unit 150 may determine data to be transmitted by the counterpart device by measuring the load change (or the load impedance change) based on a magnitude change in the current, voltage, or power of the coil. For example, the power transmitting unit 100 may communicate with the power receiving unit 150 according to an out-of-band scheme. The power transmitting unit 100 or the power receiving unit 150 may transmit and receive data using a short-range communication module (e.g., a BLE communication module) provided separately from the coil or a patch antenna. The frequency band of the wireless power and the band of the short-range communication module are separate from each other. For example, in the case of AirFuel standard, the frequency band of wireless power is 6.78 MHz and the frequency band of the short-range communication module is 2.4 GHZ.

In the disclosure, performing a specific operation by the power transmitting unit 100 or the power receiving unit 150 may imply that various hardware included in the power transmitting unit 100 or the power receiving unit 150, such as a processor (e.g., including processing circuitry), a coil, and/or a patch antenna, perform the specific operation. Performing a specific operation by the power transmitting unit 100 or the power receiving unit 150 may imply that a processor controls other hardware to perform the specific operation. Performing a specific operation by the power transmitting unit 100 or the power receiving unit 150 may imply that an instruction for performing the specific operation, stored in a storage circuit (e.g., memory) of the power transmitting unit 100 or the power receiving unit 150, is executed to cause the processor or other hardware to perform the specific operation.

The power receiving unit 150 may be at least one of, for example, a portable communication device (e.g., a smartphone), a wearable device (e.g., a watch, wireless earphones, or an AR/VR device), a portable multi-media device (e.g., a touchpad or a laptop), PDA, PMP, a camera, a portable medical device, home appliances (e.g., TV). Various other types of electronic devices may be applied.

FIG. 2 is an exploded perspective view illustrating an example electronic device and a cover device according to various embodiments.

An electronic device 200 in FIG. 2 may be the power receiving unit 150 in FIG. 1.

Referring to FIG. 2, the electronic device 200 and a cover device 300 may be detached from and attached to each other. The electronic device 200 may include a display 218 on a front surface 211. The electronic device 200 may be coupled to the cover device 300 such that a rear surface opposite the front surface 211 on which the display 218 is disposed is adjacent to the cover device 300. The cover device 300 may be coupled to the electronic device 200 such that the electronic device 200 is disposed on an inner surface 311. There are no limitations on the shape and detachment/attachment method of the electronic device 200 and the cover device 300.

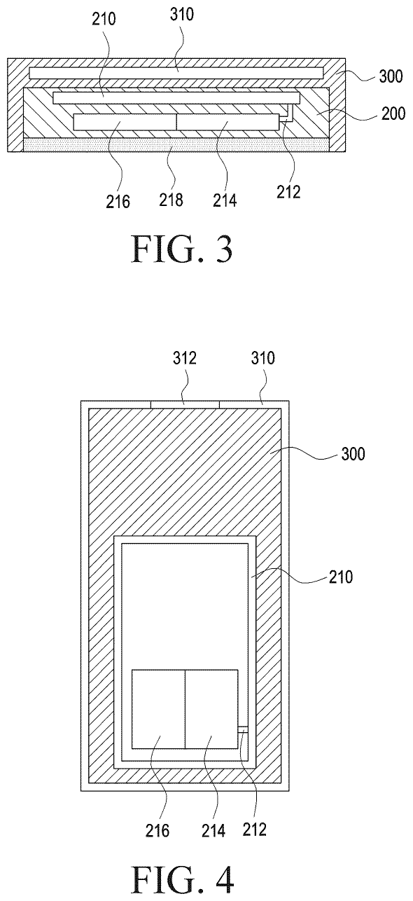

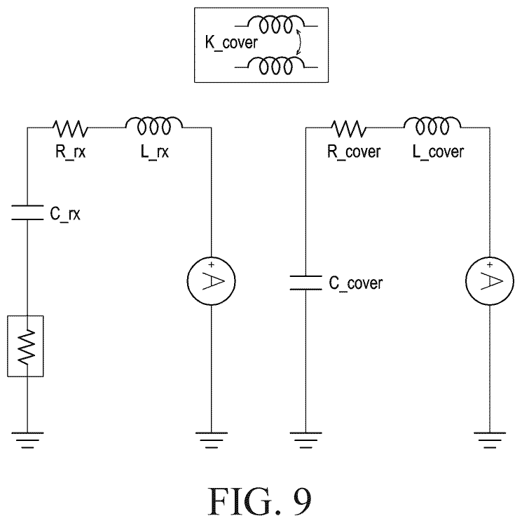

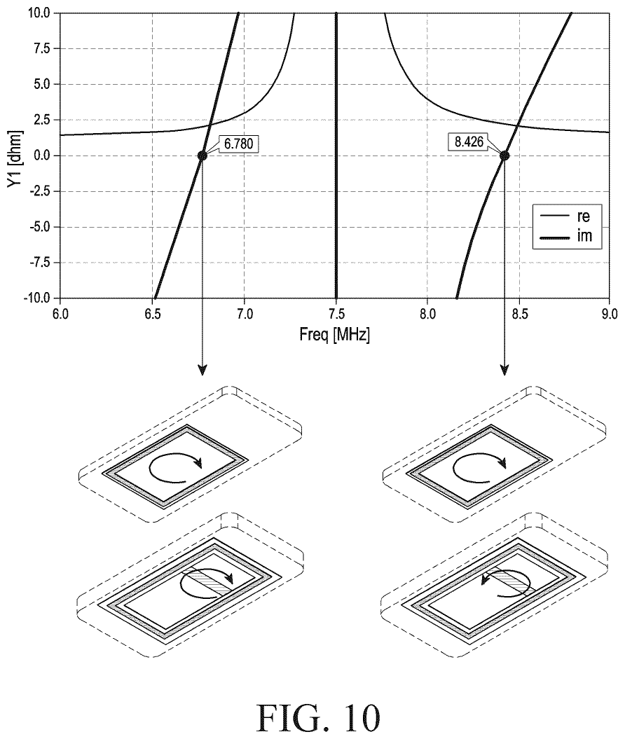

In accordance with various embodiments, the electronic device 200 may receive wireless power from the power transmitting unit 100 through the cover device 300 while the cover device 300 is coupled to the electronic device 200. In accordance with an embodiment, the electronic device 200 may also receive wireless power from the power transmitting unit 100 by the electronic device 200 alone while the electronic device 200 is separated from the cover device 300. Referring to FIGS. 3 to 8, it is possible to understand hardware elements of the electronic device 200 and the cover device 300. Referring to FIGS. 9 and 10, it is possible to understand the specifications of each element of the electronic device 200 and cover device 300 in FIGS. 3 to 8. The resonant frequency of a resonator included in the electronic device 200, the resonant frequency of a resonator included in the cover device 300, and the transmission frequency of wireless power transmitted by the power transmitting unit 100 will be described later with reference to FIGS. 9 and 10.

FIG. 3 is a cross-sectional view illustrating an example structure of resonators which are disposed in an electronic device and a cover device according to various embodiments. FIG. 4 is a diagram illustrating an example structure of resonators which are disposed in an electronic device and a cover device according to various embodiments.

FIGS. 3 and 4 illustrate elements disposed in the electronic device 200 and in the cover device 300 while the electronic device 200 is coupled to the cover device 300. FIG. 3 is a projection view of the electronic device 200 and the cover device 300 seen from below. FIG. 4 is a projection view of the electronic device 200 and the cover device 300 seen from the frontal direction (e.g., the direction toward the front surface 218 in FIG. 2). The plane on which each element illustrated in FIG. 4 is arranged may vary. Those skilled in the art can understand the arrangement structure of each element with reference to FIGS. 3 and 4. FIGS. 3 and 4 are example drawings, and thus the arrangement structure of each element is not limited.

Each of the elements arranged in the electronics device 200 and the cover device 300 will be described with reference to FIGS. 3 and 4.

In accordance with various embodiments, the cover device 300 may include a first coil 310. The first coil 310 may be embedded in a housing of the cover device 300. The first coil 310 may be disposed in a plane substantially perpendicular to the direction of coupling of the electronic device 200 and the cover device 300. The cover device 300 may include a first capacitor 312. The first capacitor 312 may be connected to the first coil 310. The first capacitor 312 and the first coil 310 may form a closed loop. The first coil 310 and the first capacitor 312 may form a first resonator. A description of the capacitance of the first capacitor 312 and the resonant frequency of the first resonator formed by the first capacitor 312 and the first coil 310 will be described in greater detail below with reference to FIGS. 9 and 10.

In accordance with various embodiments, the electronic device 200 may include a second coil 210. The second coil 210 may be embedded in the housing of the electronic device 200. The second coil 210 may be disposed in a plane substantially perpendicular to the direction of coupling of the electronic device 200 and the cover device 300. In a state in which the electronic device 200 is coupled to the cover device 300, the plane in which the second coil 210 is disposed may be substantially parallel to the plane in which the first coil 310 is disposed. The electronic device 200 may include a matching circuit 214. In accordance with an embodiment, the matching circuit 214 may include a second capacitor. The second capacitor may be connected (212) to the second coil 210. The second coil 210 and the second capacitor may form a second resonator. There are no limitations on the position where the second capacitor is disposed, and the second capacitor may be included in the matching circuit 214 or may be disposed outside the matching circuit 214. The matching circuit 214 may include a coil and a capacitor connected in series, and/or a coil and a capacitor connected in parallel. The configuration of the matching circuit 214 is not limited. The electronic device 200 may include a rectification circuit 216. The rectification circuit 216 may be connected to the matching circuit 214. The second coil 210 may be electrically connected to the matching circuit 214 and/or the rectification circuit 216 of the electronic device 200. As illustrated in FIG. 3, the matching circuit 214 and the rectification circuit 216 may be disposed in the same plane. However, this is an example, and the matching circuit 214 and the rectification circuit 216 may be disposed in different planes. The display 218 of the electronic device 200 may be disposed on the front surface of the housing of the electronic device 200 and exposed to the outside. The second coil 210 of the electronic device 200 may be disposed on the rear surface of the housing of the electronic device 200 and may be internally embedded.

According to various embodiments, a first area formed by the first coil 310 of the cover device 300 may be larger than a second area formed by the second coil 210 of the electronic device 200. The “area formed by a coil” may refer, for example, to the area of a region including a loop formed by the coil and the inside of the loop, if the coil is disposed in the form of a loop. Referring to FIG. 4, it can be observed that the area of a loop formed by the first coil 310 is larger than the area of a loop formed by the second coil 210.

In accordance with various embodiments, in a state in which the cover device 300 is coupled to the electronic device 200, at least a portion of a second region formed by the second coil 210 may be included in a first region formed by the first coil 310. In accordance with an embodiment, the second region formed by the second coil 210 may be entirely included in the first region formed by the first coil 310. The “region formed by a coil” may refer, for example, to a region that includes a loop formed by the coil and the inside of the loop. Although the first coil 310 and the second coil 210 are formed in different planes, “at least a portion of the second region formed by the second coil 210 is included in the first region formed by the first coil 310” may refer, for example, to, when the cover device 300 and the electronic device 200 are seen from the frontal direction (e.g., the front surface 211 in FIG. 2) while being coupled to each other, in the frontal projection view as in FIG. 4, at least a portion of the second region formed by the second coil 210 is included in the first region formed by the first coil 310.

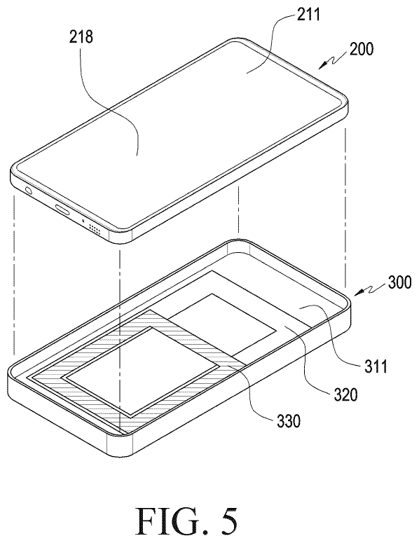

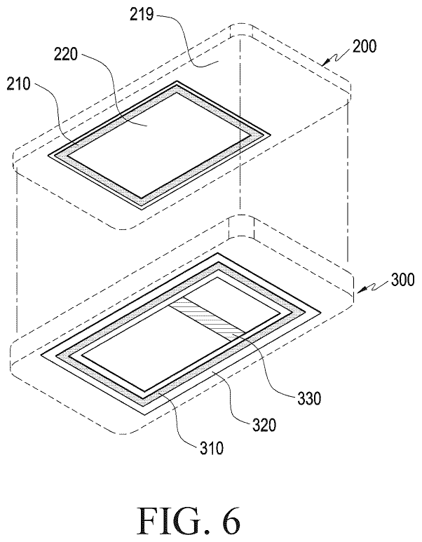

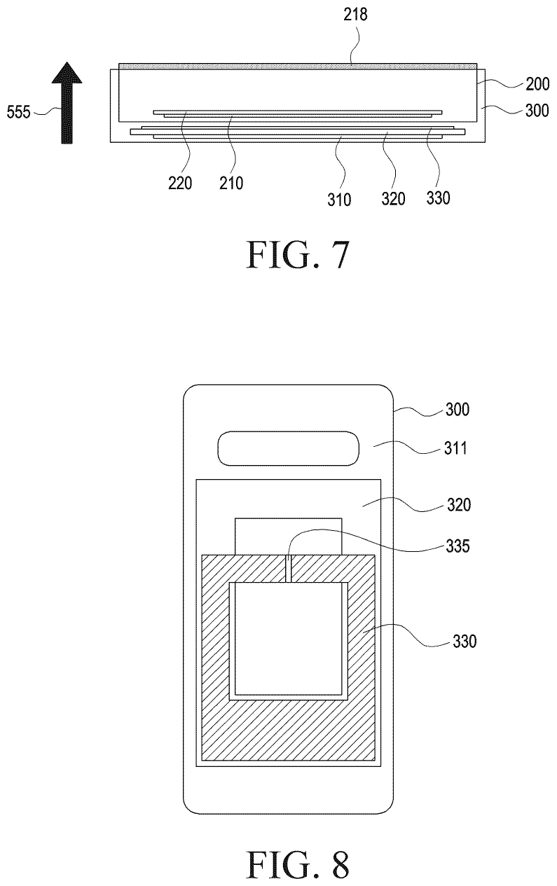

FIG. 5 is an exploded perspective view illustrating an example structure of resonators which are disposed in an electronic device and a cover device according to various embodiments. FIG. 6 is an exploded perspective view illustrating an example structure of resonators which are disposed in an electronic device and a cover device according to various embodiments. FIG. 7 is a cross-sectional view illustrating an example structure of resonators which are disposed in an electronic device and a cover device according to various embodiments.

FIGS. 5 and 6 illustrate elements that are disposed in the electronic device 200 and in the cover device 300 while the electronic device 200 is separated from the cover device 300. FIGS. 5 and 6 are projection views of the electronic device 200 and the cover device 300 seen obliquely. In FIGS. 5 and 6, each of the elements is shown as being disposed on the outside of the electronic device 200 or the cover device 300. However, this is for the sake of convenience of description, and at least some of the elements may be embedded in the electronic device 200 or the cover device 300.

FIG. 7 illustrates elements in the electronic device 200 and in the cover device 300 while the electronic device 200 is coupled to the cover device 300. FIG. 7 is a projection view of the electronic device 200 and the cover device 300 seen from below.

Each of the elements disposed in the electronic device 200 and the cover device 300 will be described with reference to FIGS. 5, 6, and 7.

In accordance with various embodiments, the cover device 300 may further include a ferrite sheet 320 disposed on at least a portion of the first coil 310. The ferrite sheet 320 may be mounted to the cover device 300. Referring to FIG. 7, the ferrite sheet 320 may be disposed on at least a portion of the first coil 310 in a coupling direction 555 (refer to FIG. 7) of the electronic device 200 and the cover device 300. Referring to FIG. 6, the ferrite sheet 320 may be formed in a ring shape. For example, the ferrite sheet 320 may be formed in a ring shape corresponding to a loop formed by the first coil 310. Referring to FIG. 5, the loop formed by the first coil 310 may be entirely covered by the ferrite sheet 320. “Covered” may refer, for example, to, when viewed from a specific direction, a specific element may overlap another element. In accordance with an embodiment, the ferrite sheet 320 may be formed in a flat shape, and the shape of the ferrite sheet 320 is not limited. The ferrite sheet 320 is an element for increasing the efficiency of receiving wireless power through the first coil 310, and serves to compensate for coupling degradation caused by metallic components of the electronic device 200. The cover device 300 includes the ferrite sheet 320, and thus may compensate for the coupling degradation caused by the metallic components of the electronic device 200.

In accordance with various embodiments, the cover device 300 may further include a metal sheet 330 disposed on at least a portion of the ferrite sheet 320. The metal sheet 330 may be mounted to the cover device 300. Referring to FIG. 7, the metal sheet 330 may be disposed on at least a portion of the ferrite sheet 320 in the coupling direction 555 (refer to FIG. 7) of the electronic device 200 and the cover device 300. Referring to FIG. 6, the metal sheet 330 may be formed in a ring shape. For example, at least a portion of the ring shape formed by the metal sheet 330 may be disposed on at least a portion of the ring shape formed by the ferrite sheet 320. Referring to FIG. 6, at least a portion of the ring shape formed by the metal sheet 330 may be covered by the ferrite sheet 320, and at least another portion of the ring shape formed by the metal sheet 330 may not be covered by the ferrite sheet 320. “Not covered” may refer, for example, to, when viewed from a specific direction, a specific element may not overlap another element. Referring to FIG. 5, an area formed by the metal sheet 330 may be smaller than an area formed by the ferrite sheet 320. For example, the area of a ring formed by the metal sheet 330 and the inner region of the ring may be smaller than the area of the ring formed by the ferrite sheet 320 and the inner region of the ring. The metal sheet 330 serves to reduce the inductance of the second coil 210 embedded in the electronic device 200. In accordance with an embodiment, the metal sheet 330 may be formed in a flat shape, and the shape of the metal sheet 330 is not limited.

In accordance with various embodiments, the electronic device 200 may further include a ferrite sheet 220 disposed on at least a portion of the second coil 210. The ferrite sheet 220 of the electronic device 200 may be embedded in the electronic device 200. Referring to FIG. 6, the second coil 210 of the electronic device 220 may be positioned closer to a rear surface 219 of the electronic device 200 than the ferrite sheet 220 of the electronic device 200. Referring to FIG. 6, the ferrite sheet 220 of the electronic device 200 may be formed in a flat shape. In accordance with an embodiment, the ferrite sheet 220 of the electronic device 200 may be formed in a ring shape corresponding to the loop formed by the second coil 210. However, this is an example, and the shape of the ferrite sheet 220 is not limited.

FIG. 8 illustrates the structure of a metal sheet disposed in a cover device according to various embodiments.

FIG. 8 is a projection view of the cover device 300 seen from the front according to various embodiments.

Referring to FIG. 8, the metal sheet 330 of the cover device 300 may include a segmented portion 335. The segmented portion 335 of the metal sheet 330 may be formed in a region not covered by the ferrite sheet 330, but this is an example and there is no limitation on the position where the segmented portion 335 is formed. For example, the segmented portion of the metal sheet 330 may be formed in a region that is covered by the ferrite sheet 330. The inductance of the second coil 210 of the electronic device 200 that is reduced by the metal sheet 330 may be determined based on the shape, size, and/or position of the segmented portion 335 of the metal sheet 330.

FIG. 9 is a diagram illustrating example circuit structures of an electronic device and a cover device according to various embodiments. FIG. 10 is a graph illustrating the resonance of an electronic device and a cover device according to various embodiments.

Referring to FIG. 9, it is possible to understand an embodiment in which the electronic device 200 and the cover device 300 receive wireless power while coupled to each other, and it is possible to understand an embodiment in which the electronic device 200 and the cover device 300 receive wireless power while separated from each other. Referring to FIG. 10, it is possible to understand resonant frequencies in an even mode and an odd mode. The “even mode” may refer, for example, to a mode in which the current direction of the first coil 310 of the cover device 300 and the current direction of the second coil 210 of the electronic device 200 are formed to be the same, and the “odd mode” may refer, for example, to a mode in which the current direction of the first coil 310 of the cover device 300 and the current direction of the second coil 210 of the electronic device 200 are formed to be different. The circuit structures and resonance of the electronic device and the cover device will be described in greater detail with reference to FIGS. 9 and 10.

In accordance with various embodiments, a resonant frequency of the second coil 210 of the electronic device 200 (e.g., a resonant frequency of a resonant circuit formed by the second coil 210 and the second capacitor of the electronic device 200) may be a transmission frequency (e.g., 6.780 MHz) of wireless power transmitted by the power transmitting unit 100. For example, an inductance (e.g., L_rx) of the second coil 210 and the second capacitor of the electronic device 200 and/or the capacitance (e.g., C_rx) of the second capacitor of the electronic device 200 may be determined such that the resonant frequency of the resonant circuit formed by the second coil 210 and the second capacitor of the electronic device 200 is the transmission frequency of the wireless power transmitted by the power transmitting unit 100. In accordance with an embodiment, a resonant frequency of the second coil 210 of the electronic device 200 may be included in a designated range that includes the transmission frequency of the wireless power (e.g., a range of +−5% of the transmission frequency). For example, the difference between the resonant frequency of the second coil 210 and the transmission frequency of the wireless power may be equal to or smaller than a reference value. For example, the electronic device 200 may include the second coil 210 having a resonant frequency that falls within the designated range that includes the transmission frequency of the wireless power (e.g., a range of +−5% of the transmission frequency).

In accordance with various embodiments, the first coil 310 and the second coil 210 may be magnetically coupled to each other. The first coil 310 may be formed such that a coupling coefficient (e.g., K_cover) between the first coil 310 and the second coil 210 is equal to or greater than a reference value. The cover device 300 may include the first coil 310 formed such that the coupling coefficient (e.g., K_cover) between the first coil 310 and the second coil 210 is equal to or greater than the reference value. The cover device 300 may receive wireless power from the power transmitting unit 100. The cover device 300 may transmit wireless power to the electronic device 200. The electronic device 200 may receive wireless power from the power transmitting unit 100 via the cover device 300. The efficiency of the wireless power that the electronic device 200 receives from the power transmitting unit 100 via the cover device 300 may be determined based on the coupling coefficient (e.g., K_cover) between the first coil 310 of the cover device 300 and the second coil 210 of the electronic device 200.

Referring to FIG. 10, the first coil 310 of the cover device 300 may be formed such that the current direction of the first coil 310 of the cover device 300 is the same as the current direction of the second coil 210 of the electronic device 200 (e.g., even mode). In accordance with various embodiments, a resonant frequency of the first coil 310 of the cover device 300 (e.g., a resonant frequency of a resonant circuit formed by the first coil 310 and the first capacitor 312 of the cover device 300) may be higher than a transmission frequency (e.g., 6.780 MHZ) of wireless power transmitted by the power transmitting unit 100. The resonant frequency of the first coil 310 may be set higher than the resonant frequency of the second coil 210. The resonant frequency of the first coil 310 of the cover device 300 may be determined based on the capacitance of the first capacitor 312. For example, an inductance (e.g., L_cover) of the first coil 310 and/or capacitance (e.g., C_cover) of the first capacitor 312 may be determined such that the resonant frequency of the resonant circuit formed by the first coil 310 and the first capacitor 312 of the cover device 300 is higher than a transmission frequency (e.g., f0) of wireless power transmitted from the power transmitting unit 100. For example, the capacitance (e.g., C_cover) of the first capacitor 312 may be determined based on the transmission frequency (e.g., f0) of the wireless power transmitted by the power transmitting unit 100. For example, the capacitance (e.g., C_cover) of the first capacitance 312 may be determined based on an inductance (e.g., L_rx) of the second coil 210 while the electronic device 200 is coupled to the cover device 300, and an inductance (e.g., L_rx0) of the second coil 210 while the cover device 300 is separated. For example, the capacitance (e.g., C_cover) of the first capacitor 312 may be determined based on the inductance (e.g., L_cover) of the first coil 310, the inductance (e.g., L_rx and L_rx0) of the second coil 210, the coupling coefficient (e.g., K_cover) between the first coil 310 and the second coil 210, and the mutual inductance (e.g., M_cover). For example, the capacitance (e.g., C_cover) of the first capacitor 312 may be determined by Equation 1 and Equation 2. However, these are examples, and the capacitance of the first capacitor 312 may have other values.

$${C}_{cover} = \frac{{L}_{rxo} - {L}_{rx}}{\begin{matrix}( {( 2 * π * f 0 )}^{2} * ( ( {L}_{rxo} - {L}_{rx} + {M}_{cover} ) * \\ {L}_{cover - ( {L}_{cover} - {M}_{cover} )} * {M}_{cover} )\end{matrix}} \qquad Equation 1$$

$${M}_{cover} = {K}_{cover} * sqrt ( {L}_{rx} * {L}_{cover} ) \qquad Equation 2$$

In accordance with various embodiments, in a state in which the electronic device 200 is separated from the cover device 300, the first resonant frequency of the first coil 310 of the cover device 300 may be higher than the transmission frequency of the wireless power transmitted by the power transmitting unit 100. In a state in which the electronic device 200 is separated from the cover device 300, a second resonant frequency of the second coil 210 of the electronic device 200 may be the transmission frequency of the wireless power transmitted by the power transmitting unit 100. In a state in which the electronic device 200 is separated from the cover device 300, the second resonant frequency of the second coil 210 of the electronic device 200 may be included in a designated range that includes the transmission frequency of the wireless power transmitted by the power transmitting unit 100. In a state in which the electronic device 200 is coupled to the cover device 300, the final resonant frequency of the first coil 310 of the cover device 300, formed by interference with the second coil 210 of the electronic device 200, may be the transmission frequency of the wireless power transmitted by the power transmitting unit 100 or may be included in the designated range including the transmission frequency.

In accordance with various embodiments, the quality factor of the first resonator, formed by the first coil 310 and the first capacitor 312 of the cover device 300, may be greater than the quality factor of the second resonator, formed by the second coil 210 and the second capacitor of the electronic device 200. The quality factor may be the reciprocal of a loss rate.

In accordance with various embodiments, referring to FIGS. 2 to 10, the electronic device 200 may achieve higher wireless power transmission efficiency when receiving wireless power from the power transmitting unit 100 through the cover device 300 while the cover device 300 is coupled to the electronic device 200, compared to when the electronic device 200 alone receives wireless power from the power transmitting unit 100 while the cover device 300 is separated.

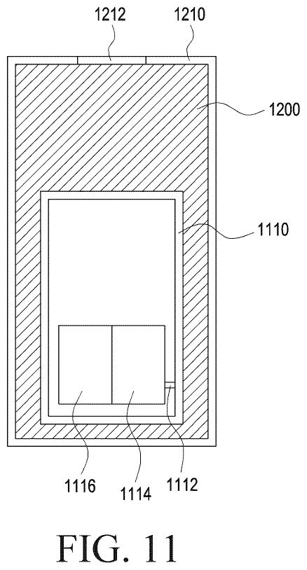

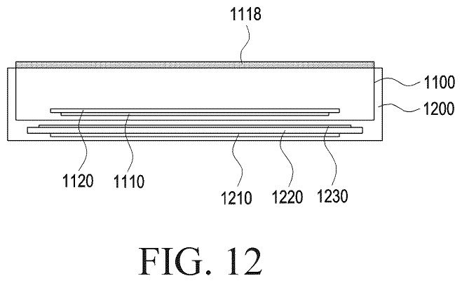

FIG. 11 is a diagram illustrating an example structure of a resonator of an electronic device including a cover according to various embodiments. FIG. 12 is a diagram illustrating an example structure of a resonator of an electronic device including a cover according to various embodiments.

FIGS. 11 and 12 illustrate an electronic device 1100 including a cover 1200. The electronic device 1100 in FIGS. 11 and 12 may be the power receiving unit 150 in FIG. 1. In accordance with various embodiments, the electronic device 1100 integrated with a cover may be provided. The electronic device 1100 in FIGS. 11 and 12 may be configured similarly to the electronic device 200 in FIGS. 2 to 8, except for being integrated with a cover. The description of the electronic device 1100 in FIGS. 11 and 12 will be omitted within the scope of redundancy with the description of the electronic device 200 in FIGS. 2 to 8. A description that is not explicitly made of elements included in the electronic device 1100 in FIGS. 11 and 12 may be understood to be identical to the description of the elements included in the electronic device 200 in FIGS. 2 to 8.

Referring to FIG. 12, the electronic device 1100 may include a display 1118 on a front surface thereof. The electronic device 1100 may include a cover 1200 as a part of a housing of the electronic device 1100. For example, the electronic device 1100 may include the display 1118 disposed on one side of the housing and the cover 1200 disposed on the other side of the housing opposite the display 1118. The electronic device 1100 may include a first coil 1210, a first ferrite sheet 1220, and a metal sheet 1230 mounted to the cover 1200. The first ferrite sheet 1220 may be disposed on at least a portion of the first coil 1210. The metal sheet 1230 may be disposed on at least a portion of the first ferrite sheet 1220. The electronic device 1100 may include a second coil 1110 and a second ferrite sheet 1120, disposed in the electronic device 1100. The second coil 1110 may be disposed between the display 1118 and the cover 1200. Referring to FIG. 11, the electronic device 1100 may include a first capacitor 1212 connected to the first coil 1210. The electronic device 1100 may include a matching circuit 1114 connected (1112) to the second coil 1110. The electronic device 1100 may include a rectification circuit 1116 connected to the matching circuit 1114.

The first coil 1210, first capacitor 1212, the second coil 1110, the matching circuit 1114, and the rectification circuit 1116 in FIG. 11 may correspond to the first coil 310, the first capacitor 312, the second coil 210, the matching circuit 214, and the rectification circuit 216 in FIG. 4, respectively. For example, a first area formed by the first coil 1210 may be larger than a second area formed by the second coil 1110. When viewed from the rear surface of the electronic device 1100, the first area formed by the first coil 1210 may include at least a portion of the second area formed by the second coil 1110. The coupling coefficient between the first coil 1210 and the second coil 1110 may be equal to or greater than a reference value. The capacitance of the first capacitor 1212 may be determined based on a transmission frequency of wireless power transmitted from the power transmitting unit 100. The first coil 1210 and the first capacitor 1212 may form a closed loop. The resonant frequency of the first coil 1210 (e.g., the resonant frequency of a resonant circuit formed by the first coil 1210 and the first capacitor 1212) may be determined based on the capacitance of the first capacitor 1212. The resonant frequency of the first coil 1210 may be higher than the transmission frequency of the wireless power transmitted by the power transmitting unit 100. The resonant frequency of the second coil 1110 may be the transmission frequency of the wireless power transmitted by the power transmitting unit 100. Alternatively, the resonant frequency of the second coil 1110 may be included in a designated range that includes the transmission frequency of the wireless power transmitted by the power transmitting unit 100.

The first coil 1210, the first ferrite sheet 1220, the metal sheet 1230, the second coil 1110, and the second ferrite sheet 1120 in FIG. 12 may correspond to the first coil 310, the ferrite sheet 320, the metal sheet 330, the second coil 210, and the ferrite sheet 220 in FIG. 6, respectively. For example, the first ferrite sheet 1220 may be disposed on at least a portion of the first coil 1210. The first ferrite sheet 1220 may be formed in a ring shape. The metal sheet 1230 may be disposed on at least a portion of the first ferrite sheet 1220. The metal sheet 1230 may be formed in a ring shape. The metal sheet 1230 may include a segmented portion. An area formed by the metal sheet 1230 may be smaller than an area formed by the ferrite sheet 1220.

In accordance with various embodiments, referring to FIGS. 11 and 12, the electronic device 1100 may include the first coil 1210, the first ferrite sheet 1220, and/or the metal sheet 1230 mounted to the cover 1200, resulting in a higher efficiency of wireless power transmission from the power transmitting unit 100 compared to when the first coil 1210, the first ferrite sheet 1220, and the metal sheet 1230 are not mounted to the cover 1200.

The omitted portions of the description in FIGS. 11 and 12 may be understood by reference to the description in FIGS. 2 to 8. For example, the description of the segmented portion of the metal sheet 1230 may be understood by reference to the description of the segmented portion of the metal sheet 330.

In accordance with various example embodiments, a cover device (e.g., the cover device 300) couplable to a power receiving unit (e.g., the power receiving unit 150 or the electronic device 200) comprising circuitry configured to receive wireless power from a power transmitting unit (e.g., the power transmitting unit 100) comprising circuitry may include: a first capacitor (e.g., the first capacitor 312), a first coil (e.g., the first coil 310) connected to the first capacitor, a ferrite sheet (e.g., the ferrite sheet 320) disposed on at least a portion of the first coil in a coupling direction (e.g., the coupling direction 555) of the power receiving unit and the cover device, and a metal sheet (e.g., the metal sheet 330) disposed on a least a portion of the ferrite sheet in the coupling direction of the power receiving unit and the cover device. The first capacitor and the first coil may be configured to form a closed loop. A first resonant frequency of the first coil may be higher than a second resonant frequency of a second coil (e.g., the second coil 210) of the power receiving unit.

In accordance with various example embodiments, the second resonant frequency may be a transmission frequency of the wireless power.

In accordance with various example embodiments, the ferrite sheet may be formed in a ring shape.

In accordance with various example embodiments, the metal sheet may be formed in a ring shape.

In accordance with various example embodiments, the metal sheet may include a segmented portion (e.g., the segmented portion 335).

In accordance with various example embodiments, an area formed by the metal sheet may be smaller than an area formed by the ferrite sheet.

In accordance with various example embodiments, a first area formed by the first coil may be larger than a second area formed by the second coil.

In accordance with various example embodiments, in a state where the power receiving unit is coupled to the cover device, the second region formed by the second coil may be included in the first region formed by the first coil.

In accordance with various example embodiments, the first coil may be formed such that a coupling coefficient between the first coil and the second coil is equal to or greater than a reference value.

In accordance with various example embodiments, capacitance of the first capacitor may be determined based on a transmission frequency of the wireless power transmitted from the power transmitting unit.

In accordance with various example embodiments, the first resonant frequency may be determined based on the capacitance of the first capacitor.

In accordance with various example embodiments, a power receiving unit (e.g., the power receiving unit 150 or the electronic device 1100) comprising circuitry configured to receive wireless power from a power transmitting unit (e.g., the power transmitting unit 100) comprising circuitry may include: a housing, a display (e.g., the display 1118) disposed on one side of the housing, and a cover (e.ge. the cover 1200) disposed on an other side of the housing opposite the display. The cover may include: a first capacitor (e.g., the first capacitor 1212), a first coil (e.g., the first coil 1210) connected to the first capacitor, a ferrite sheet (e.g., the ferrite sheet 1220) disposed in a direction of the one side on at least a portion of the first coil, and a metal sheet (e.g., the metal sheet 1230) disposed in the direction of the one side on at least a portion of the ferrite sheet. The power receiving unit may include a second coil (e.g., the second coil 1110) disposed between the display and the cover. The first capacitor and the first coil may be configured to form a closed loop. A first resonant frequency of the first coil may be higher than a second resonant frequency of the second coil.

In accordance with various example embodiments, the second resonant frequency may be a transmission frequency of the wireless power.

In accordance with various example embodiments, the ferrite sheet may be formed in a ring shape.

In accordance with various example embodiments, the metal sheet may be formed in a ring shape.

In accordance with various example embodiments, an area formed by the metal sheet may be smaller than an area formed by the ferrite sheet.

In accordance with various example embodiments, a first area formed by the first coil may be larger than a second area formed by the second coil.

In accordance with various example embodiments, the second region formed by the second coil may be included in the first region formed by the first coil.

In accordance with various example embodiments, the first coil may be formed such that a coupling coefficient between the first coil and the second coil is equal to or greater than a reference value.

In accordance with various example embodiments, capacitance of the first capacitor may be determined based on a transmission frequency of the wireless power transmitted from the power transmitting unit.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure including the appended claims and their equivalents. It will also be understood that any of the embodiment(s) described herein may be use in conjunction with any other embodiment(s) described herein.

What is claimed is:

1. A cover device couplable to a power receiving unit comprising circuitry configured to receive wireless power from a power transmitting unit comprising circuitry, the cover device comprising:
a first capacitor;
a first coil connected to the first capacitor;
a ferrite sheet disposed on at least a portion of the first coil in a direction of coupling between the power receiving unit and the cover device; and
a metal sheet disposed on a least a portion of the ferrite sheet in the direction of coupling between the power receiving unit and the cover device,
wherein the first capacitor and the first coil form a closed loop, and
wherein a first resonant frequency of the first coil is higher than a second resonant frequency of a second coil of the power receiving unit.

2. The cover device of claim 1, wherein the second resonant frequency is a transmission frequency of the wireless power.

3. The cover device of claim 1, wherein the ferrite sheet has a ring shape.

4. The cover device of claim 1, wherein the metal sheet has a ring shape.

5. The cover device of claim 4, wherein the metal sheet comprises a segmented portion.

6. The cover device of claim 1, wherein an area of the metal sheet is smaller than an area of the ferrite sheet.

7. The cover device of claim 1, wherein a first area of the first coil is larger than a second area of the second coil.

8. The cover device of claim 1, wherein in a state where the power receiving unit is coupled to the cover device, a second region formed by the second coil is included in a first region formed by the first coil.

9. The cover device of claim 1, wherein the first coil is formed such that a coupling coefficient between the first coil and the second coil is equal to or greater than a reference value.

10. The cover device of claim 1, wherein a capacitance of the first capacitor is determined based on a transmission frequency of the wireless power transmitted from the power transmitting unit.

11. The cover device of claim 10, wherein the first resonant frequency is determined based on the capacitance of the first capacitor.

12. A power receiving unit comprising circuitry configured to receive wireless power from a power transmitting unit comprising circuitry, the power receiving unit comprising:
a housing;
a display disposed on one side of the housing;
a cover disposed on an other side of the housing opposite the display, the cover comprising a first capacitor, a first coil connected to the first capacitor, a ferrite sheet disposed in a direction of the one side on at least a portion of the first coil, and a metal sheet disposed in the direction of the one side on at least a portion of the ferrite sheet; and
a second coil disposed between the display and the cover,
wherein the first capacitor and the first coil form a closed loop, and
a first resonant frequency of the first coil is higher than a second resonant frequency of the second coil.

13. The power receiving unit of claim 12, wherein the second resonant frequency is a transmission frequency of the wireless power.

14. The power receiving unit of claim 12, wherein the ferrite sheet has a ring shape.

15. The power receiving unit of claim 12, wherein the metal sheet has a ring shape.

16. The power receiving unit of claim 12, wherein an area of the metal sheet is smaller than an area of the ferrite sheet.

17. The power receiving unit of claim 12, wherein a first area of the first coil is larger than a second area of the second coil.

18. The power receiving unit of claim 12, wherein the second region formed by the second coil is included in the first region formed by the first coil.

19. The power receiving unit of claim 12, wherein the first coil is formed such that a coupling coefficient between the first coil and the second coil is equal to or greater than a reference value.

20. The power receiving unit of claim 12, wherein a capacitance of the first capacitor is determined based on a transmission frequency of the wireless power transmitted from the power transmitting unit.
